(19) United States
(12) Patent Application Publication
(10) Pub. No.: US 2026/0080518 A1
(43) Pub. Date: Mar. 19, 2026

(54) METHOD AND APPARATUS WITH MOTION GENERATION AND CAPTURING

(71) Applicant: Samsung Electronics Co., Ltd., Suwon-si (KR)

(72) Inventors: Kinam KWON, Suwon-si (KR); Bartosz NIEDZWIEDZ, Suwon-si (KR); Maciej MARCINKIEWICZ, Suwon-si (KR); Lukasz CHUDORLINSKI, Suwon-si (KR); Hana LEE, Suwon-si (KR); Hyong Euk LEE, Suwon-si (KR); Pawel KIES, Suwon-si (KR)

(73) Assignee: Samsung Electronics Co., Ltd., Suwon-si (KR)

(21) Appl. No.: 19/326,575

(22) Filed: Sep. 11, 2025

(30) Foreign Application Priority Data
Sep. 13, 2024 (KR) 10-2024-0125856

(51) Int. Cl. G06T 5/73; G06T 5/60; H04N 23/68

(52) U.S. Cl. CPC G06T 5/73; G06T 5/60; H04N 23/683; H04N 23/687; G06T 2207/20201

(57) ABSTRACT

An electronic apparatus including processors configured to execute instructions and a memory storing the instructions, and an execution of the instructions configures the processors to generate a control signal corresponding to a desired motion of a capturing device respective to a scene to be captured, and control a motion generator, the motion generator being configured to sequentially provide a first motion for generating a blur image and a second motion for generating a sharp image to a capturing device, based on the control signal, the blur image being generated using the capturing device set to a first capturing parameter while the first motion is provided to the capturing device and the sharp image being generated using the capturing device set to a second capturing parameter while the second motion is provided to the capturing device.

### CROSS-REFERENCE TO RELATED APPLICATIONS

This application claims the benefit under 35 USC § 119(a) of Korean Patent Application No. 10-2024-0125856, filed on Sep. 13, 2024, in the Korean Intellectual Property Office, the entire disclosure of which is incorporated herein by reference for all purposes.

### BACKGROUND

### 1. Field

The following description relates to an apparatus and method with motion generation and capturing.

### 2. Description of Related Art

Deblurring may refer to a process of making a blurry or blurred image (i.e., a blur image) into a sharp image. Blurring may be caused by shaking, poor focus, and/or a low-light environment. For example, motion blur may be caused by movements of a camera or a subject. By reducing or removing this blurring through deblurring, a blur image may be restored to a sharp image. For example, deblurring may be performed using mathematical algorithms and/or artificial intelligence. When a mathematical algorithm is used, the cause of blurring may be analyzed and a blurring process may be estimated in reverse to perform deblurring. When artificial intelligence is used, a sharp image may be derived from a blur image using a restoration model trained using pairs of blur images and sharp images.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an electronic apparatus including processors configured to execute instructions and a memory storing the instructions, and an execution of the instructions configures the processors to generate a control signal corresponding to a desired motion of a capturing device respective to a scene to be captured, and control a motion generator, the motion generator being configured to sequentially provide a first motion for generating a blur image and a second motion for generating a sharp image to a capturing device, based on the control signal, the blur image being generated using the capturing device set to a first capturing parameter while the first motion is provided to the capturing device and the sharp image being generated using the capturing device set to a second capturing parameter while the second motion is provided to the capturing device.

The motion generator may include a position sensor configured to receive the first motion and the second motion simultaneously with the capturing device.

Each of the first motion and the second motion may be corrected using the position sensor.

The providing of the first motion and the second motion may include generating the first motion and the second motion based on a position sequence including position components and correcting the first motion and the second motion based on an error between a target position indicated by the position components and an actual position sensed by the position sensor.

The processors may be further configured to control the capturing device to move to an initial position using the position sensor after the first motion ends and before the second motion starts.

The motion generator may be configured to sequentially apply the first motion and the second motion to the capturing device by moving the capturing device while holding the capturing device.

The first motion may be a translation motion and the second motion may be a rotation motion.

The motion may be a same motion as the second motion.

The motion generator may include an actuator configured to generate power based on the control signal, a first power transmitter configured to generate a first motion component of a first direction, based on the power, a second power transmitter configured to generate a second motion component of a second direction, based on the power, and a device holder configured to hold the capturing device and apply the first motion and the second motion to the capturing device based on the first motion component and the second motion component to the capturing device while holding the capturing device.

A first exposure time of the first capturing parameter may be longer than a second exposure time of the second capturing parameter.

In a general aspect, here is provided a motion generator including processors configured to execute instructions and a memory storing the instructions, and an execution of the instructions configures the processors to control an actuator configured to generate power, the power being applied to a first power transmitter configured to generate a first motion component of a first direction, based on the power, a second power transmitter configured to generate a second motion component of a second direction, based on the power, and a device holder configured to hold a capturing device and sequentially apply a first motion for generating a blur image and a second motion for generating a sharp image, based on the first motion component and the second motion component, to the capturing device while holding the capturing device.

The processors may be further configured to control the capturing device to capture the blur image by setting the capturing device to a first capturing parameter while the first motion is provided to the capturing device and control the capturing device to capture the sharp image by setting the capturing device to a second capturing parameter while the second motion is provided to the capturing device.

The processors may be further configured to control a position sensor to receive the first motion and the second motion simultaneously with the capturing device.

The processors may be further configured to correct each of the first motion and the second motion using the position sensor.

Each of the first motion and the second motion may be generated based on a position sequence including position components and the processors may be further configured to correct a target position based on an error between indicated by the position components and an actual position sensed by the position sensor.

The processors may be further configured to control the motion generator to move the capturing device to an initial position using the position sensor, after the first motion ends and before the second motion starts.

In a general aspect, here is provided a processor-implemented method including sequentially providing a first motion for capturing, by an image capture apparatus, a blur image and a second motion for capturing a sharp image to the image capture apparatus, based on a control signal to record a scene in both the blur image and the sharp image, generating the blur image using the image capture apparatus being set to a first capturing parameter while the first motion is provided to the capturing device, and generating the sharp image using the image capture apparatus being set to a second capturing parameter while the second motion is provided to the image capture apparatus.

The method may include generating the first motion and the second motion based on a position sequence including position components and correcting the first motion and the second motion based on an error between a target position indicated by the position components and an actual position sensed by a position sensor configured to receive the first motion and the second motion simultaneously with the image capture apparatus.

The method may include storing a plurality of blur images and sharp images related to the scene in a blur-sharp image pair database and training a neural network using the blur-sharp image pair database to form a deblurring model.

The method may include storing a plurality of blur images and sharp images related to the scene in a blur-sharp image pair database and determining a benchmark for the image capture apparatus using the blur-sharp image pair database.

Other features and aspects will be apparent from the following detailed description, the drawings, and the claims.

### BRIEF DESCRIPTION OF THE DRAWINGS

FIG. 1 illustrates an example electronic apparatus according to one or more embodiments.

FIG. 2 illustrates an example capturing apparatus according to one or more embodiments.

FIG. 3 illustrates an example motion generated by capturing apparatus according to one or more embodiments.

FIG. 4 illustrates an example of exposure time and irradiance for each of a blur image and a sharp image according to one or more embodiments.

FIG. 5 illustrates an example electronic apparatus for performing motion correction according to one or more embodiments.

FIG. 6 illustrates an example method of generating a motion by a motion generator according to one or more embodiments.

FIG. 7 illustrates an example electronic apparatus according to one or more embodiments.

FIG. 8 illustrates an example method of a capturing process according to one or more embodiments.

FIG. 9 illustrates an example capturing method according to one or more embodiments.

FIG. 10 illustrates an electronic apparatus according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

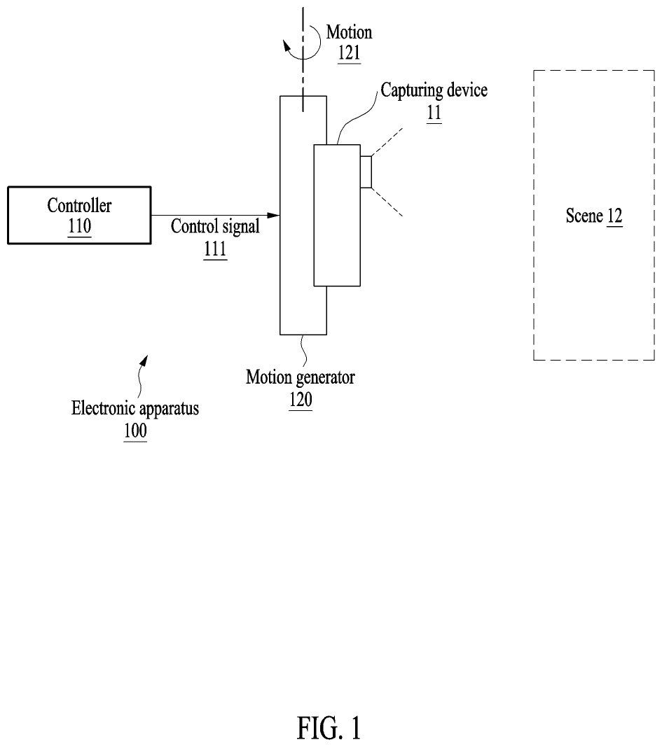

FIG. 1 illustrates an example capturing apparatus according to one or more embodiments. Referring to FIG. 1, in a non-limiting example, electronic apparatus 100 may include an controller 110 and a motion generator 120.

The controller 110 may generate a control signal 111 corresponding to a desired motion. The desired motion may refer to a motion 121 used to generate a pair of images including a blur image and a sharp image with respect to a scene 12 to be captured by a capturing device 11. For example, the desired motion may include a handshake, a walking, a motion based on an arbitrary function, an arbitrary motion, or a combination thereof. The desired motion may be determined by the controller 110, another device (e.g., an electronic device or a computing device distinct from the electronic apparatus 100), or a combination thereof.

The motion generator 120 may generate the motion 121 based on the control signal 111. The motion 121 may be applied to the capturing device 11. The capturing device 11 may capture the scene 12 to generate an image while the motion 121 is being applied thereto. The scene 12 may be a fixed or still image so that the capturing device may capture multiple versions of a same image. In an example, the motion 121 may include a first motion and a second motion. The first motion may be used to generate a blur image, and the second motion may be used to generate a sharp image. The motion generator 120 may sequentially apply the first motion and the second motion to the capturing device 11. The motion generator 120 may sequentially apply the motion 121 (e.g., the first motion and/or the second motion) to the capturing device 11 by moving the capturing device 11 while holding the capturing device 11. The first motion and the second motion may be the same or different.

The motion 121 (e.g., the first motion and/or the second motion) may include one or more of a translation motion and a rotation motion. For example, the motion 121 may be defined as 6 degrees of freedom (6 DOF). The translational motion may correspond to a translation based on one or more of three mutually orthogonal coordinate axes (e.g., an x-axis, a y-axis, and a z-axis). The rotation motion may correspond to a rotation based on one or more of three mutually orthogonal coordinate axes (e.g., the x-axis, the y-axis, and the z-axis). For example, the rotation motion may be based on one or more of roll, pitch, and yaw.

The capturing device 11 may be set to different capturing parameters while different motions are applied to the capturing device 11. The capturing device 11 may capture the scene 12 using the different capturing parameters. For example, a capturing parameter may include exposure time, an aperture value, an International Organization for Standardization (ISO) value, white balance, focal length, lens distance, or a combination thereof. The ISO value may correspond to a gain.

In an example, the capturing device 11 may be set to a first capturing parameter to capture the blur image and may be set to a second capturing parameter to capture the sharp image. The capturing device 11 may include an image sensor. Due to different exposure levels of the image sensor, the blur image and the sharp image may be separately obtained based on the different exposure levels. Sensor exposure may be determined based on the exposure time, the aperture value, and the ISO value. When the capturing device 11 is a mobile device (e.g., a smartphone, an action camcorder, smart glasses, a smart watch, and a wearable device), the aperture value may be fixed. In this case, the sensor exposure may be determined based on the exposure time and the ISO value. Longer exposure time may result in higher blur level, and greater ISO value may result in higher noise level. In an example, the capturing device 11 may capture the blur image and the sharp image by adjusting the exposure time between these images.

In an example, the blur image may be captured using the capturing device 11 set to the first capturing parameter while the first motion is applied to the capturing device 11. The sharp image may be captured using the capturing device 11 set to the second capturing parameter while the second motion is applied to the capturing device 11. A first exposure time of the first capturing parameter may be longer than a second exposure time of the second capturing parameter.

A pair including the blur image and the sharp image may be captured using the electronic apparatus 100 and the capturing device 11. This type of pair may be called a blur-sharp image pair. Numerous blur-sharp image pairs may be captured by repetitive capturing actions performed by the electronic apparatus 100 and the capturing device 11. The electronic apparatus 100 may automatically perform repetitive capturing corresponding to various desired motions. The electronic apparatus 100 may precisely implement these desired motions. Based on these numerous blur-sharp image pairs, a blur-sharp image pair database may be formed. In an example, the blur-sharp image pair database may be used as training data for deep learning or to determine a benchmark for the capturing device 11.

In an example, deep learning of a deblurring model based on a neural network may be performed based on the blur-sharp image pair database. The deep learning of a deblurring model may require a large training data set including pairs of blur images and sharp images. Deblurring performance of the deblurring model may be determined depending on specifications of the training data set. Typically, there may be difficulties in obtaining a sophisticated, large-scale training data set. The electronic apparatus 100 may precisely implement the desired motions, and a high-quality training data set may be obtained.

In an example, capturing performance (e.g., deblurring performance and blur control performance) of the capturing device 11 may be measured based on various desired motions implemented using the electronic apparatus 100. A benchmark of the capturing device 11 may be determined based on the capturing performance of the capturing device 11. According to an example, various desired motions applied to the capturing device 11 may be applied to other capturing devices that are distinct from the capturing device 11, and the capturing performance and/or benchmark of the other capturing devices may be determined. Accordingly, capturing performances and benchmarks of various capturing devices may be determined under the same test environment, and the capturing performances and benchmarks may be compared with each other.

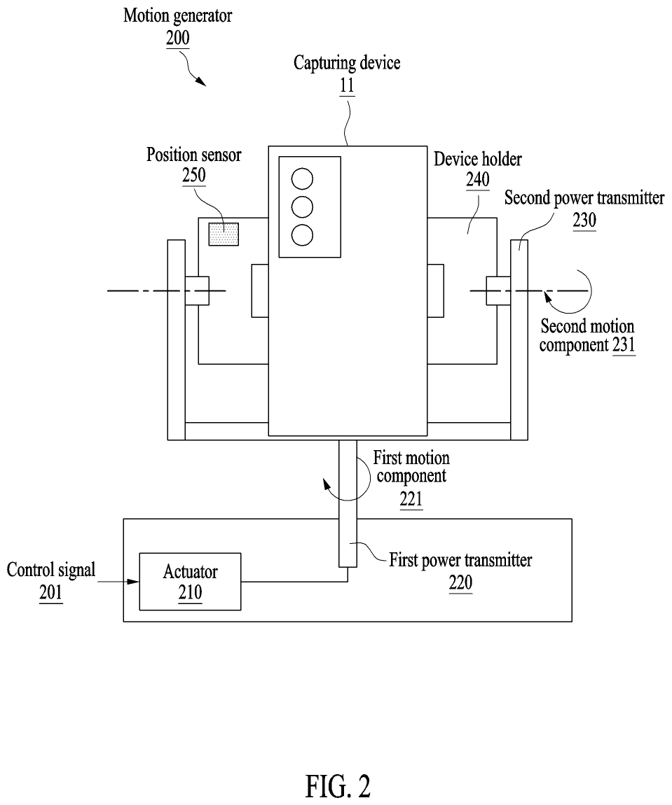

FIG. 2 illustrates an example capturing apparatus according to one or more embodiments.

Referring to FIG. 2, in a non-limiting example, a motion generator 200 may include an actuator 210, a first power transmitter 220, a second power transmitter 230, a device holder 240, and a position sensor 250. In an example, the motion generator 200 may generate a first motion component 221 and a second motion component 231 that may be centered on two mutually orthogonal axes. However, examples are not limited thereto. For example, unlike the example illustrated in FIG. 2, the motion generator 200 may instead generate three motion components centered on three mutually orthogonal axes. For example, the first motion component 221 may be a yaw component and the second motion component 231 may be a pitch component, but again, examples are not limited thereto.

In an example, the actuator 210 may generate power, or motion, based on a control signal 201. For example, the actuator 210 may generate power for linear and/or rotational motion. For example, the actuator 210 may be a motor (e.g., a voice coil motor). The actuator 210 may include sub-configurations for appropriately generating motion components. For example, the actuator 210 may include a first sub-actuator (e.g., a first voice coil motor) for generating the first motion component 221 and a second sub-actuator (e.g., a second voice coil motor) for generating the second motion component 231.

The first power transmitter 220 may generate the first motion component 221 in a first direction, based on the power generated by the actuator 210. The second power transmitter 230 may generate the second motion component 231 in a second direction, based on the power generated by the actuator 210. The first direction and the second direction may be directions of rotation centered on mutually orthogonal axes. A combined motion (e.g., the first motion for the blur image and/or the second motion for the sharp image) of the first motion component 221 and the second motion component 231 may be provided to the capturing device 11.

In an example, the device holder 240 may hold the capturing device 11 and may apply one or more motions (e.g., the first motion and/or the second motion) to the capturing device 11 based on the first motion component 221 and the second motion component 231, while holding the capturing device 11. The device holder 240 may be coupled to the second power transmitter 230 to form a rotation axis for the second motion component 231. The second power transmitter 230 may be coupled to the first power transmitter 220 to form a rotation axis for the first motion component 221. For example, bearings may be used in these couplings.

In an example, the position sensor 250 may receive the first motion and/or the second motion simultaneously with the capturing device 11. For example, the position sensor 250 may be fixed to the device holder 240. The position sensor 250 may sense an absolute position and/or a relative position. For example, the position sensor 250 may include an optical position sensor, a magnetic position sensor, a mechanical position sensor, an ultrasonic waves position sensor, a proximity sensor, an accelerometer, a gyroscope, an inertial measurement unit, or a combination thereof.

In an example, there may be an error between an intended target motion and an actual motion which may be due to an implementation issue. The error may be corrected using the position sensor 250. The position sensor 250 may measure the actual motion of the capturing device 11. The target motion indicated by the control signal 201 may be compared with the actual motion sensed by the position sensor 250. A comparison result may represent the error between the target motion and the actual motion. The control signal 201 and the motion (the first motion and/or the second motion) may be adjusted to reduce the error derived using the position sensor 250.

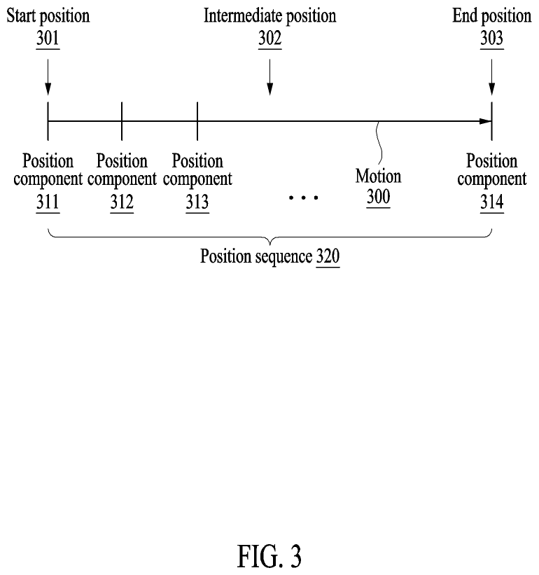

FIG. 3 illustrates an example motion generated by capturing apparatus according to one or more embodiments.

Referring to FIG. 3, in a non-limiting example, a motion 300 (e.g., a first motion and/or a second motion) may be defined based on a start position 301, an intermediate position 302, and an end position 303. The start position 301, the intermediate position 302, and the end position 303 may be determined based on a desired motion. A motion generator may generate the motion 300 based on the start position 301, the intermediate position 302, and the end position 303.

In an example, the motion 300 may be generated based on a position sequence 320 including position components 311 to 314. The position components 311 to 314 may represent positions of successive moments for implementing the motion 300. In an example, the position components 311 to 314 may have equal temporal and/or spatial intervals. For example, the position component 311 may correspond to the start position 301 and the position component 314 may correspond to the end position 303. The intermediate position 302 may correspond to an intermediate position between the position component 311 and the position component 314.

In an example, the motion 300 may be corrected based on an error between a target position indicated by the position components 311 to 314 and an actual position sensed by a position sensor. The target position may represent a target position to implement the motion 300. The actual position may represent a position sensed by the position sensor. Due to an implementation issue, there may be an error between the target position and the actual position. The error may be calculated for one or more of the position components 311 to 314, and a control signal and the motion 300 may be corrected to reduce the error. For example, a correction value (e.g., a value opposite to the error) that may eliminate the error may be determined, and the control signal and the motion 300 may be corrected based on the correction value.

In an example, motion correction may be performed based on initial position components (e.g., a predetermined number of position components) of the motion 300. When the error is reduced through the motion correction, the error may tend to not reoccur. For example, during the process of the motion 300, the error may be gradually reduced through the error correction, and when the error becomes smaller than a threshold value, the motion correction may be terminated. In this case, motion generation may be performed without requiring additional motion correction.

In an example, the motion generator may perform position initialization after generating the motion 300. The motion generator may perform the position initialization to move a capturing device to an initial position. The position initialization may be performed using the position sensor. For example, the motion generator may use the position sensor to move the capturing device to the initial position after the first motion ends and before the second motion starts. The position sensor may sense the actual position for moving the capturing device to the initial position. The initial position may be, but is not limited to, the start position 301. When the initial position is the start position 301, motion generation may be performed at the same position (e.g., the initial position and the start position 301) in a repetitive motion generation process (e.g., generation of each of the first motion and the second motion). Accordingly, predetermined motions may be generated under a predetermined condition. Accordingly, a sophisticated training data set and/or a sophisticated benchmark result may be derived.

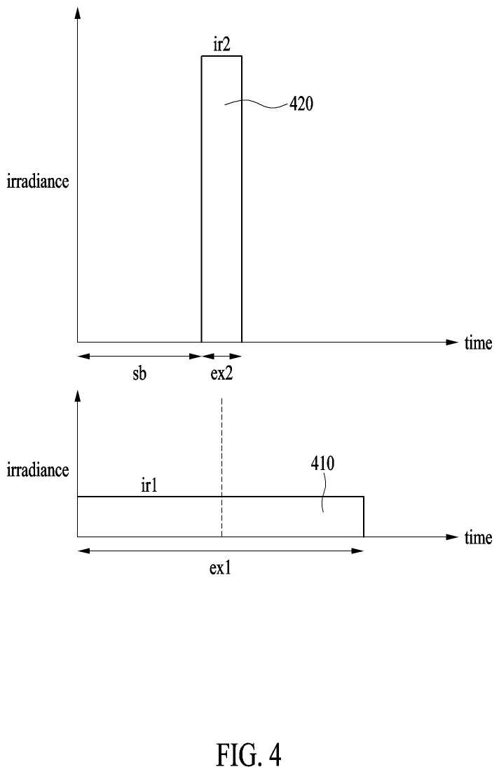

FIG. 4 illustrates an example of exposure time and irradiance for each of a blur image and a sharp image according to one or more embodiments.

Referring to FIG. 4, in a non-limiting example, the blur image may be generated based on a first exposure ex1 and a first irradiance ir1 corresponding to a first graph 410, and the sharp image may be generated based on a second exposure ex2 and a second irradiance ir2 corresponding to a second graph 420. The irradiance may refer to light energy obtained by an image sensor of a capturing device.

In an example, a first exposure time of the first exposure ex1 may be greater than a second exposure time of the second exposure ex2, and the first irradiance ir1 may be less than the second irradiance ir2. A first area of the first graph 410 and a second area of the second graph 420 may be the same.

The second exposure ex2 of the image sensor for generating the sharp image may be performed after a waiting time sb. In an example, the center of the first exposure ex1 may be the same as the center of the second exposure ex2. For example, when a first motion for capturing the blur image is the same as a second motion for capturing the sharp image, when the first motion and the second motion each include a first position component, a second position component, and a third position component, and when the first position component is a start position, the second position component is an intermediate position, and the third position component is an end position, then the first exposure ex1 may be performed while the capturing device goes through the first position component, the second position component, and the third position component, and the second exposure ex2 may be performed while the capturing device goes through the second position component after waiting for the waiting time sb.

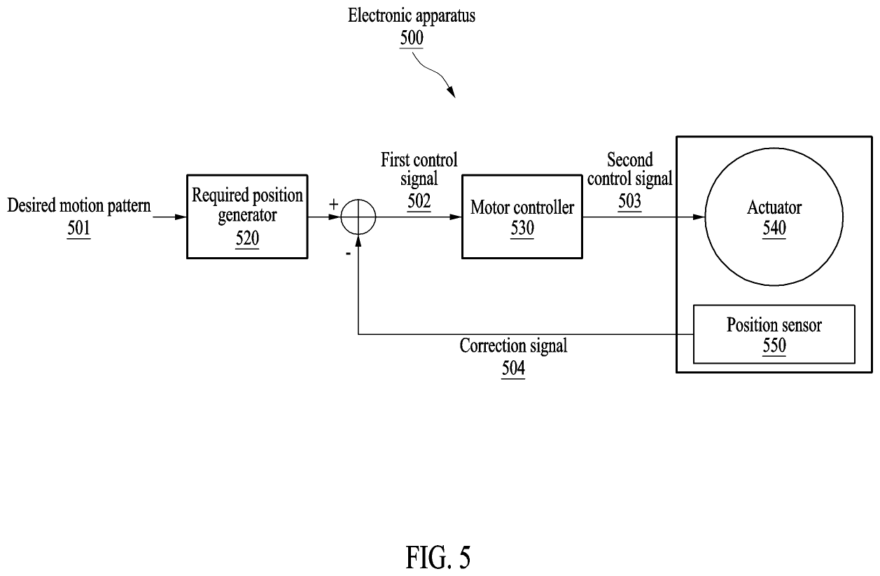

FIG. 5 illustrates an example electronic apparatus for performing motion correction according to one or more embodiments.

Referring to FIG. 5, in a non-limiting example, electronic apparatus 500 may include a required position generator 520, a motor controller 530, an actuator 540, and a position sensor 550. The required position generator 520 and the motor controller 530 may correspond to an controller (e.g., controller 110).

In an example, the required position generator 520 may generate a first control signal 502 based on a desired motion pattern 501. The motor controller 530 may generate a second control signal 503 based on the first control signal 502. The actuator 540 may generate power based on the second control signal 503. For example, the actuator 540 may be a motor (e.g., a voice coil motor) and the second control signal 503 may be a voltage signal. The actuator 540 may generate power dependent on the voltage signal. The first control signal 502 and the second control signal 503 may correspond to a control signal generated by the controller.

In an example, the position sensor 550 may sense an actual position of a capturing device. A correction signal 504 may be generated based on an error between a target position indicated by position components and the actual position sensed by the position sensor 550. The first control signal 502 may be adjusted based on the correction signal 504. For example, the correction signal 504 may correspond to a correction value (e.g., a value opposite to the error) that may eliminate the error, and the first control signal 502 may be corrected based on the correction signal 504.

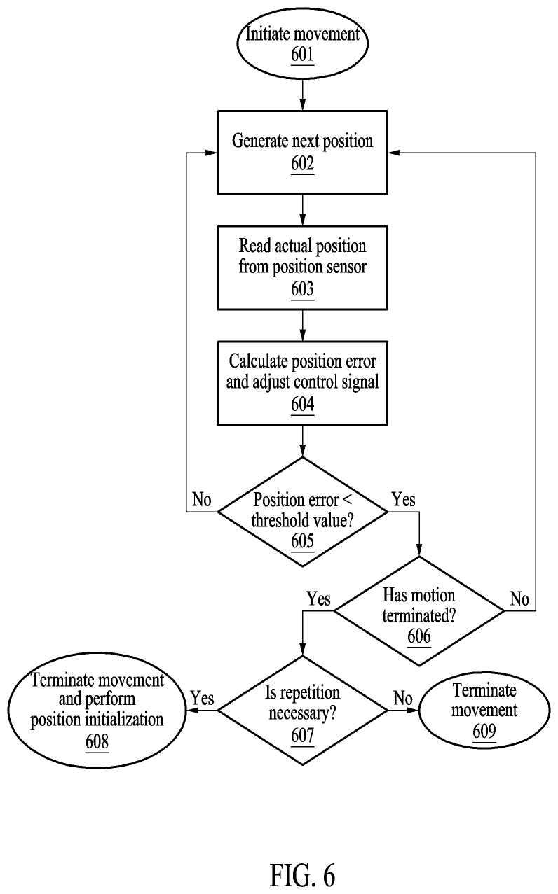

FIG. 6 illustrates an example method of generating a motion by a motion generator according to one or more embodiments.

Referring to FIG. 6, in a non-limiting example, a movement of a capturing device may be initiated by the motion generator in operation 601. The movement of the capturing device may begin from a start position.

In an example, in operation 602, a next position may be generated by the motion generator. For example, a motion may include position components, and the next position may correspond to a next position component of a position component corresponding to the start position.

In an example, in operation 603, an actual position may be read from a position sensor. There may be an error between a target position indicated by the next position component and the actual position sensed by the position sensor. In an example, in operation 604, the motion generator may calculate a position error and may adjust a control signal. For example, the control signal may be adjusted based on a correction signal.

In an example, in operation 605, the position error may be compared to a threshold value. When the position error is greater than the threshold value, operation 602 may be performed again. Accordingly, the control signal may be repeatedly corrected so that the position error may be reduced.

In an example, operation 606 may be performed when the position error is less than the threshold value. In operation 606, it may be determined whether the motion has terminated. For example, when a current position component is the final position component, the motion may be determined to be terminated.

When the motion is not terminated, operation 602 may be performed again. A predetermined delay may be inserted between operation 606 and operation 602. When the motion is terminated, operation 607 may be performed.

In an example, in operation 607, it may be determined whether repetition is necessary. When additional generation of other motions is required, it may be determined that repetition is necessary. For example, when a first motion is generated for a blur image, it may be determined that repetition is necessary to generate a second motion for a sharp image.

In an example, operation 608 may be performed when repetition is necessary. In operation 608, movement of a current motion may be terminated and position initialization may be performed. The capturing device may be moved to the initial position according to the position initialization. After the position initialization, operation 601 may be performed again for a next motion (e.g., the second motion). Operation 609 may be performed when repetition is unnecessary. In an example, in operation 609, the movement of the capturing device may be terminated. In operation 609, the motion generator may be powered off without additional movement of the capturing device.

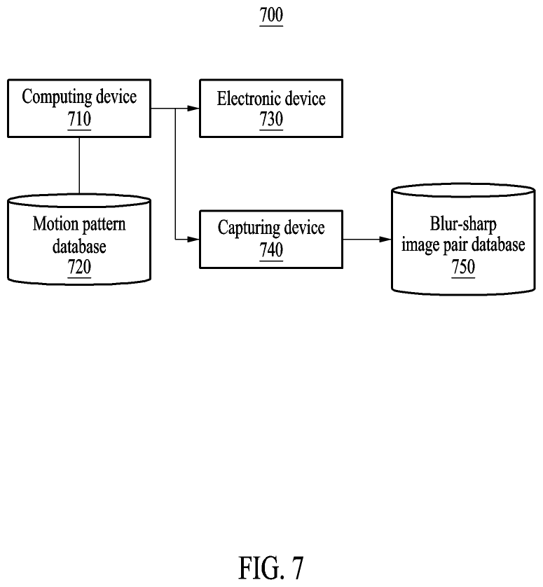

FIG. 7 illustrates an example motion generation system according to one or more embodiments.

Referring to FIG. 7, in a non-limiting example, a motion generation system 700 may include a computing device 710, a motion pattern database 720, capturing apparatus 730, a capturing device 740, and a blur-sharp image pair database 750.

The computing device 710 may control the capturing apparatus 730 (e.g., a capturing controller) and the capturing device 740. The computing device 710 may notify the capturing apparatus 730 of a desired motion and may transmit a capturing command to the capturing device 740. The computing device 710 may trigger the capturing apparatus 730 and the capturing device 740 so that motion generation of the capturing apparatus 730 is synchronized with capturing of the capturing device 740. In an example, the capturing device 740 may be a camera, image capture apparatus, or other an imaging device.

The motion pattern database 720 may store various motion patterns. For example, the motion patterns may include a handshake, a walking, a motion based on an arbitrary function, an arbitrary motion, or a combination thereof. The computing device 710 may select desired motions from the motion patterns in the motion pattern database 720.

When blur-sharp image pairs are generated by the capturing device 740, the blur-sharp image pairs may form the blur-sharp image pair database 750. The blur-sharp image pairs in the blur-sharp image pair database 750 may be used as training data for deep learning or used to determine a benchmark of the capturing device 740.

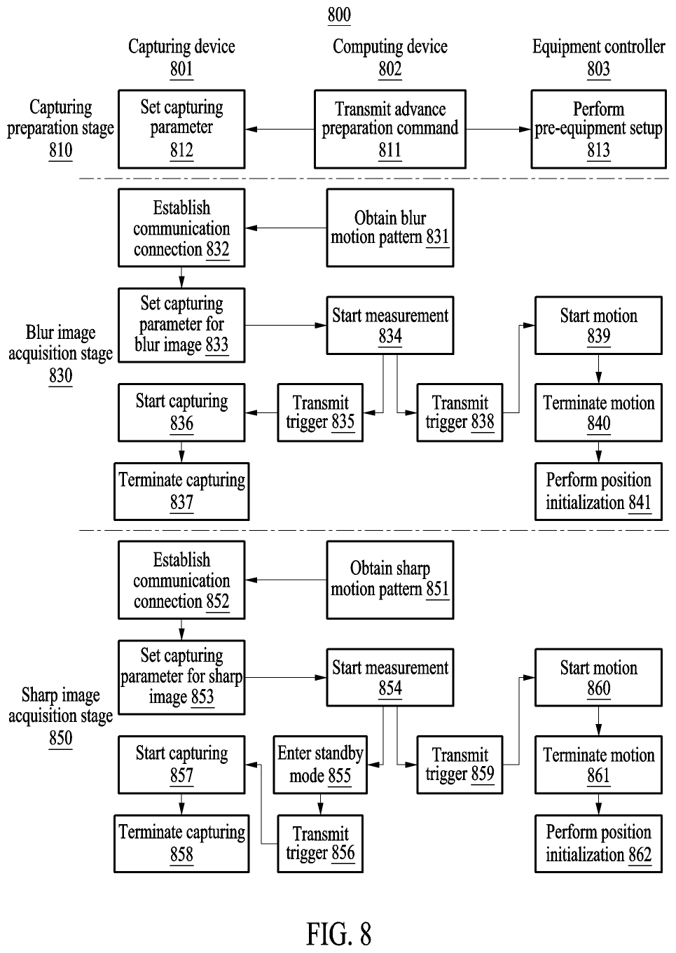

FIG. 8 illustrates an example method of a capturing process using a capturing device, a computing device, and a controller according to one or more embodiments.

Referring to FIG. 8, in a non-limiting example, the method 800 may include a capturing preparation stage 810, a blur image acquisition stage 830, and a sharp image acquisition stage 850 which may be performed by a capturing device 801 (e.g., capturing device 11), a computing device 802 (e.g., computing device 710), and a controller 803 (e.g., controller 110). Although FIG. 8 illustrates the blur image acquisition stage 830 as being performed before the sharp image acquisition stage 850, the blur image acquisition stage 830 may be performed before the sharp image acquisition stage 850, or the sharp image acquisition stage 850 may be performed before the blur image acquisition stage 830.

In an example, in operation 811 of the capturing preparation stage 810, the computing device 802 may transmit an advance preparation command to the capturing device 801 and/or the controller 803. In operation 812, the capturing device 801 may set a capturing parameter. For example, the capturing device 801 may prepare a capturing parameter for a blur image and a capturing parameter for a sharp image. In operation 813, the controller 803 may perform pre-equipment setup. For example, the controller 803 may prepare a motion sequence and/or amplitude and period of an oscillator.

In an example, in operation 831 of the blur image acquisition stage 830, the computing device 802 may initiate an obtaining of a blur motion pattern. The computing device 802 may notify the controller 803 of the blur motion pattern as a desired motion. In operation 832, the capturing device 801 may establish a communication connection with the computing device 802. In operation 833, the capturing device 801 may set the capturing parameter for the blur image.

In operation 834, the computing device 802 may being measuring (i.e., start a measurement). In operation 835, the computing device 802 may transmit a trigger to the capturing device 801. In operation 836, the capturing device 801 may start capturing based on the trigger. In operation 837, the capturing device 801 may terminate the capturing. In operation 838, the computing device 802 may transmit the trigger to the controller 803. The triggering of operation 835 may be synchronized with the triggering of operation 838. The controller 803 may start the motion in operation 839 and may terminate the motion in operation 840. In operation 841, the controller 803 may perform position initialization.

In an example, in operation 851 of the sharp image acquisition stage 850, the computing device 802 may initiate an obtaining of a sharp motion pattern. The computing device 802 may notify the controller 803 of the sharp motion pattern as a desired motion.

The blur motion pattern of operation 831 and the sharp motion pattern of operation 851 may be the same or different. In operation 852, the capturing device 801 may establish a communication connection with the computing device 802. In operation 855, the capturing device 801 may set the capturing parameter for the sharp image.

In operation 854, the computing device 802 may initiate, or start, a measurement. In operation 855, the computing device 802 may enter a standby mode for a waiting time. Exposure of an image sensor for generating the sharp image may be performed after the waiting time so that the center of a first exposure for obtaining the blur image is the same as the center of a second exposure for obtaining the sharp image.

In operation 856, the computing device 802 may transmit the trigger to the capturing device 801 after the waiting time. In operation 857, the capturing device 801 may start capturing based on the trigger. In operation 858, the capturing device 801 may terminate capturing. In operation 859, the computing device 802 may transmit the trigger to the controller 803. The triggering of operation 856 may be synchronized with the triggering of operation 859. The controller 803 may start the motion in operation 860 and may terminate the motion in operation 861. In operation 862, the controller 803 may perform position initialization.

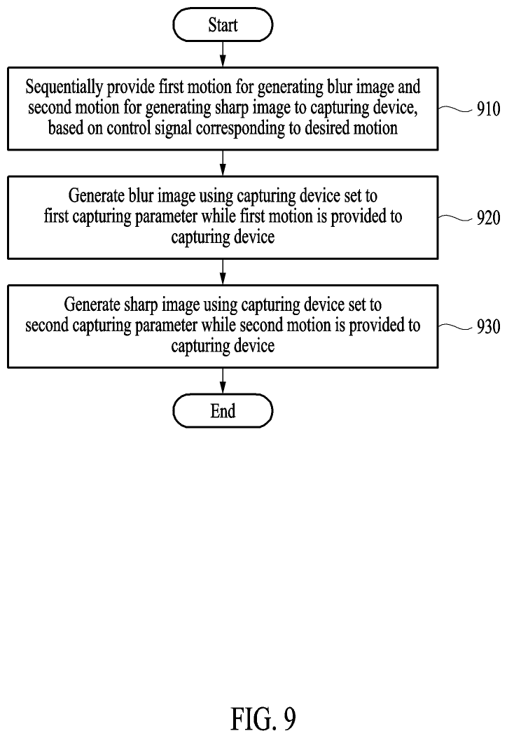

FIG. 9 illustrates an example capturing method according to one or more embodiments.

Referring to FIG. 9, in a non-limiting example, the capturing apparatus may sequentially provide a first motion for generating a blur image and a second motion for generating a sharp image to a capturing device, based on a control signal corresponding to a desired motion, in operation 910, may generate the blur image using the capturing device set to a first capturing parameter while the first motion is provided to the capturing device, in operation 920, and may generate the sharp image using the capturing device set to a second capturing parameter while the second motion is provided to the capturing device.

The first motion and the second motion may each be generated based on a position sequence including position components. The first motion and the second motion may each be corrected based on an error between a target position indicated by the position components and an actual position sensed by a position sensor configured to receive the first motion and the second motion simultaneously with the capturing device.

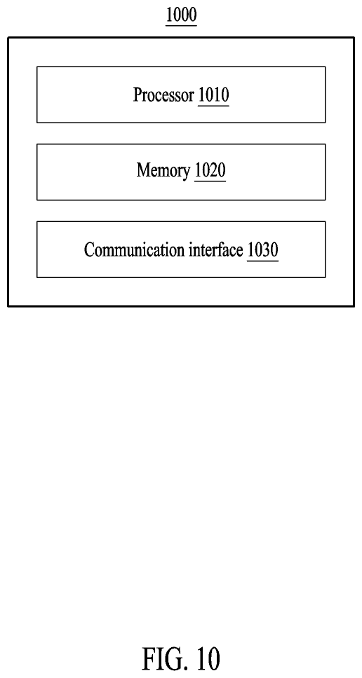

FIG. 10 illustrates an electronic apparatus according to one or more embodiments.

Referring to FIG. 10, in a non-limiting example, an electronic apparatus 1000 according to one embodiment may include a processor 1010 and a memory 1020, and a communication interface 1030. In an example, the electronic apparatus 1000 may be a controller for controlling an electronic apparatus for capturing images (e.g., electronic apparatus 100 and controller 110) and/or a motion generator, though examples are not limited thereto. For example, the electronic device 1000 may be, or included in, a portable communication terminal (e.g., a mobile phone), a smartphone, tablet personal computer (PC), a wearable device, a medical device, an Internet of Thing (IoT) device, a PC, a laptop, a server, a media player, or a vehicle device (e.g., a navigation system device).

The processor 1010 (or processors) may execute instructions (e.g., code and/or programs), and/or may control other operations or functions of the electronic apparatus 1000, the electronic apparatus and controller (e.g., electronic apparatus 100 and controller 110), and operations of the motion generator (e.g., motion generator 200), and may include any one or a combination of two or more of, for example, a central processing unit (CPU), a graphic processing unit (GPU), a neural processing unit (NPU) and tensor processing units (TPUs), but is not limited to the above-described examples. The processor 1010 may include the processing elements. The processor 1010 may control an operation of an electronic apparatus (e.g., electronic apparatus 500) including a positional generator, a motor controller, an actuator, and a position sensor. In an example, the processor 1010 may comprise the computing device 710 of the motion generation system 700.

The memory 1020 may include computer-readable instructions. The processor 1010 may be configured to execute computer-readable instructions, such as those stored in the memory 1020, and through execution of the computer-readable instructions, the processor 1010 is configured to perform one or more, or any combination, of the operations and/or methods described herein.

In addition, the memory 1020 may store various pieces of information generated during the processing process of the processor 1010 described above. In addition, the memory 1020 may store a variety of data and programs. The memory 1020 may include volatile memory or non-volatile memory. The memory 1020 may include a high-capacity storage medium such as a hard disk to store a variety of data. The memory 1020 may include the blur-sharp database 750 and the motion pattern database of 720 of the motion generation system 700.

The communication interface 1030 (e.g., an I/O interface) may include user interface may provide the capability of inputting and outputting information regarding the electronic apparatus and motion generator, the electronic apparatus 100, motion generation system 700, and other devices. The communication interface 750 may include a network module for connecting to a network and a module for forming a data transfer channel with a mobile storage medium. In addition, the communication interface may enable communication with the electronic apparatuses, motion generating devices, and databases (e.g., blur-sharp database 750 and the motion pattern database of 720).

The electronic apparatuses, processors, memories, controllers, interfaces, databases, neural networks, electronic apparatus 100, controller 110, motion generator 120, capturing device 11, motion generator 200, position sensor 250, actuator 210, electronic apparatus 500, required position generator 520, motor controller 420, actuator 540, position sensor 550, motion generation system 700, computing device 710, motion pattern database 720, electronic device 730, capturing device 730, blue-sharp image pair database 750, electronic apparatus 1000, processors 1010, memories 1020, and communication interface 1030 described herein and disclosed herein described with respect to FIGS. 1-10 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic apparatus, the electronic apparatus comprising:
processors configured to execute instructions; and
a memory storing the instructions, wherein execution of the instructions configures the processors to:
generate a control signal corresponding to a desired motion of a capturing device respective to a scene to be captured; and
control a motion generator, the motion generator being configured to sequentially provide a first motion for generating a blur image and a second motion for generating a sharp image to a capturing device, based on the control signal,
wherein the blur image is generated using the capturing device set to a first capturing parameter while the first motion is provided to the capturing device, and
wherein the sharp image is generated using the capturing device set to a second capturing parameter while the second motion is provided to the capturing device.

2. The electronic apparatus of claim 1, wherein the motion generator comprises a position sensor configured to receive the first motion and the second motion simultaneously with the capturing device.

3. The electronic apparatus of claim 2, wherein each of the first motion and the second motion is corrected using the position sensor.

4. The electronic apparatus of claim 2, wherein the providing of the first motion and the second motion comprises:
generating the first motion and the second motion based on a position sequence including position components; and
correcting the first motion and the second motion based on an error between a target position indicated by the position components and an actual position sensed by the position sensor.

5. The electronic apparatus of claim 2, wherein the processors are configured to:
control the capturing device to move to an initial position using the position sensor after the first motion ends and before the second motion starts.

6. The electronic apparatus of claim 1, wherein the motion generator is configured to sequentially apply the first motion and the second motion to the capturing device by moving the capturing device while holding the capturing device.

7. The electronic apparatus of claim 1, wherein the first motion comprises a translation motion, and
wherein the second motion comprises a rotation motion.

8. The electronic apparatus of claim 1, wherein the first motion is a same motion as the second motion.

9. The electronic apparatus of claim 1, wherein the motion generator comprises:
an actuator configured to generate power based on the control signal;
a first power transmitter configured to generate a first motion component of a first direction, based on the power;
a second power transmitter configured to generate a second motion component of a second direction, based on the power; and
a device holder configured to hold the capturing device and apply the first motion and the second motion to the capturing device based on the first motion component and the second motion component to the capturing device while holding the capturing device.

10. The electronic apparatus of claim 1, wherein a first exposure time of the first capturing parameter is longer than a second exposure time of the second capturing parameter.

11. A motion generator, comprising:
processors configured to execute instructions; and
a memory storing the instructions, wherein execution of the instructions configures the processors to:
control an actuator configured to generate power, wherein the power is applied to: a first power transmitter configured to generate a first motion component of a first direction, based on the power;
a second power transmitter configured to generate a second motion component of a second direction, based on the power; and
a device holder configured to hold a capturing device and sequentially apply a first motion for generating a blur image and a second motion for generating a sharp image, based on the first motion component and the second motion component, to the capturing device while holding the capturing device.

12. The motion generator of claim 11, wherein the processors are configured to:
control the capturing device to capture the blur image by setting the capturing device to a first capturing parameter while the first motion is provided to the capturing device, and
control the capturing device to capture the sharp image by setting the capturing device to a second capturing parameter while the second motion is provided to the capturing device.

13. The motion generator of claim 11, wherein the processors are further configured to:
control a position sensor to receive the first motion and the second motion simultaneously with the capturing device.

14. The motion generator of claim 13, wherein the processors are further configured to:
correct each of the first motion and the second motion using the position sensor.

15. The motion generator of claim 13, wherein each of the first motion and the second motion is generated based on a position sequence including position components, and
wherein the processors are further configured to:
correct a target position based on an error between indicated by the position components and an actual position sensed by the position sensor.

16. The motion generator of claim 13, wherein the processors are further configured to:
control the motion generator to move the capturing device to an initial position using the position sensor, after the first motion ends and before the second motion starts.

17. A processor-implemented method, the method comprising:
sequentially providing a first motion for capturing, by an image capture apparatus, a blur image and a second motion for capturing a sharp image to the image capture apparatus, based on a control signal to record a scene in both the blur image and the sharp image;
generating the blur image using the image capture apparatus being set to a first capturing parameter while the first motion is provided to the capturing device; and
generating the sharp image using the image capture apparatus being set to a second capturing parameter while the second motion is provided to the image capture apparatus.

18. The method of claim 17, further comprising:
generating the first motion and the second motion based on a position sequence including position components; and
correcting the first motion and the second motion based on an error between a target position indicated by the position components and an actual position sensed by a position sensor configured to receive the first motion and the second motion simultaneously with the image capture apparatus.

19. The method of claim 17, further comprising:
storing a plurality of blur images and sharp images related to the scene in a blur-sharp image pair database; and
training a neural network using the blur-sharp image pair database to form a deblurring model.

20. The method of claim 17, further comprising:
storing a plurality of blur images and sharp images related to the scene in a blur-sharp image pair database; and
determining a benchmark for the image capture apparatus using the blur-sharp image pair database.
